(19) United States
(12) Patent Application Publication
(10) Pub. No.: US 2024/0368858 A1
(43) Pub. Date: Nov. 7, 2024

(54) Forced Air Thawing System for Machinery Undercarriages

(71) Applicant: Dana A. Hennessy, Clarendon, PA (US)

(72) Inventor: Dana A. Hennessy, Clarendon, PA (US)

(21) Appl. No.: 18/553,808

(22) PCT Filed: Mar. 31, 2022
(86) PCT No.: PCT/US2022/022849

§ 371 Date: Oct. 3, 2023

Related U.S. Application Data
(60) Provisional application No. 63/169,452, filed on Apr. 1, 2021.

(51) Int. Cl. E02F 9/22; E02F 9/02; E02F 9/24

(52) U.S. Cl. CPC E02F 9/226; E02F 9/02; E02F 9/24

(57) ABSTRACT

A thawing system for heating an undercarriage of a machine is presented. The thawing system comprises a forced air system in fluid connection with a heating element. An insulated conduit connected to the outlet of the heating element is configured to transport heated air from the heating element towards the undercarriage. A plurality of outlets within the undercarriage that branch from the insulated conduit comprise a nozzle configured to direct heated air to targeted areas of the undercarriage.

### BACKGROUND

In winter weather conditions, ice, snow, and frozen mud build up on the undercarriage of construction machines and equipment during operation. Track driven machines such as bulldozers or excavators, are prone to this undercarriage buildup that must be thawed before the machine can be fully operated. It can take an operator roughly 30 to 90 minutes per each workday to properly clean the undercarriage of a machine by thawing various components of the machine so that the machine can be activated. Sometimes operators even need to use propane torches to thaw the frozen undercarriages and/or use tools to chip snow, ice, or mud from the undercarriage of the machines they operate.

Prior systems rely on hydraulic circulation of a heated liquid throughout a system of high-pressure lines. These lines circulate heated hydraulic fluid through the undercarriage of a machine to deliver heat for thawing. Heat from these systems had to conduct through the lines to enter the undercarriage, which was found to be inefficient. Prior art systems had to position the lines in contact with or in close proximity to the components that needed thawing. Some of these systems require power from the engine to operate the hydraulic pump that circulates the heated fluid through the undercarriage. Furthermore, the fluids used in this system could freeze or become highly viscous within the lines during winter weather conditions when the system was not in use. To avoid this, these systems had to run continuously when the engine wasn't operating to prevent ice from ever forming.

To solve this problem and the drawbacks of prior art systems, the thawing system disclosed herein has been created. The thawing system is safe to use, helps minimize operator time spent on maintenance of the undercarriage, and reduces the need to replace frozen parts of the undercarriage. To accomplish this, the thawing system directs heated air throughout the undercarriage of the machine to melt ice and warm key components.

### SUMMARY

What is presented is a thawing system for heating the undercarriage of an engine driven machine that has components that are prone to a buildup of ice, snow, and mud. This buildup tends to freeze when the machine in no longer being operated, which prevents certain components from being activated the next time the machine is used. The thawing system presented herein comprises a heating element in line with a forced air system such as a high-pressure blower or air compressor. The heating element and forced air system may be powered by the machines onboard rechargeable battery so that the entire thawing system may be operate independently from the engine.

The heating element produces thermal energy for the thawing system and can be activated and/or stay activated when the engine is not active. Air from the forced air system is heated as it passes through the heating element. Heated air then travels into an insulated conduit connected to the outlet of the heating element. The conduit may be insulated with foam, fiberglass, rubber, a chemical coating, or any other material that may prevent heat loss from the air traveling through the conduit. The insulated conduit carries the heated air through the machine towards the undercarriage, where the conduit splits into multiple outlets. Each outlet comprises an air nozzle that may direct the heated air to an area of the undercarriage that is prone to ice buildup. Each nozzle may have multiple ports such that each outlet may direct heated air over a larger area within the undercarriage, which is beneficial in providing heat to groups of components that may freeze together.

This direct, convective heating of frozen components is far more efficient than existing thawing systems and serves the added benefit of blowing debris out of the undercarriage. Ice, snow, mud, and other debris in the undercarriage of the machine may be quickly melted and ejected from the machine by the flow of heated air from the nozzles.

The conduit may also run along the machine's other fluid lines such as the hydraulic lines. Heat that conducts through the walls of the conduit will not be wasted as it may warm the fluid within the adjacent lines to prepare the machine for operation. Alternatively, at least one of the system's nozzles may be directed towards fluid line junctions to provide heat to the machine's hydraulic fluids. Heating of these lines helps to warm the machine's hydraulic fluids to lower their viscosity and improve efficiency of the machine.

In some embodiments, each nozzle may be heated by an electric current from the same power source that powers the heating element and forced air system. Heated nozzles may be activated before the heating element and forced air system to melt any ice that may have accumulated on the nozzles themselves.

In some embodiments of the thawing system, a heat sensor is placed at the input and output of the heating element to quantify the amount of heating being transferred from the heating element to the air from the forced air system. An onboard controller may monitor these heat sensors and adjust the power to the heating element or speed of the forced air system to produce air at a desired temperature. Heat sensors may also be added within the undercarriage to monitor its temperature during thawing so the thawing system may be automatically shutoff when the undercarriage has reached an acceptable temperature.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings:

FIG. 1 is a side view of a thawing system installed on a machine that is an excavator; and

FIG. 2 is an overhead view of the thawing system and machine of FIG. 1; and

FIG. 3 is a view of the feedback loop that controls the output temperature of an embodiment of the thawing system; and

FIG. 4 is a view of an nozzle thawing an area of a machine's undercarriage.

### DETAILED DESCRIPTION

Referring to the drawings, some of the reference numerals are used to designate the same or corresponding parts through several of the embodiments and figures shown and described, Corresponding parts are denoted in different embodiments with the addition of lowercase letters. Variations of corresponding parts in form or function that are depicted in the figures are described. It will be understood that variations in the embodiments can generally be interchanged without deviating from the invention.

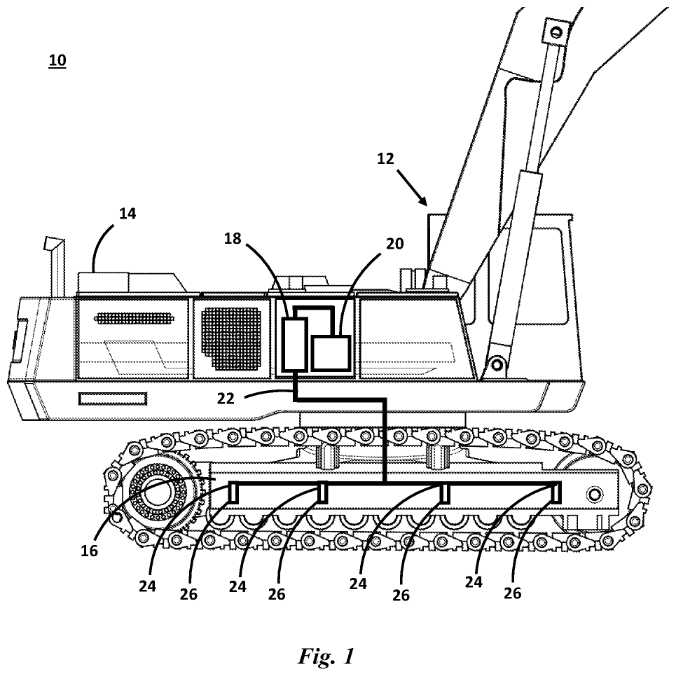

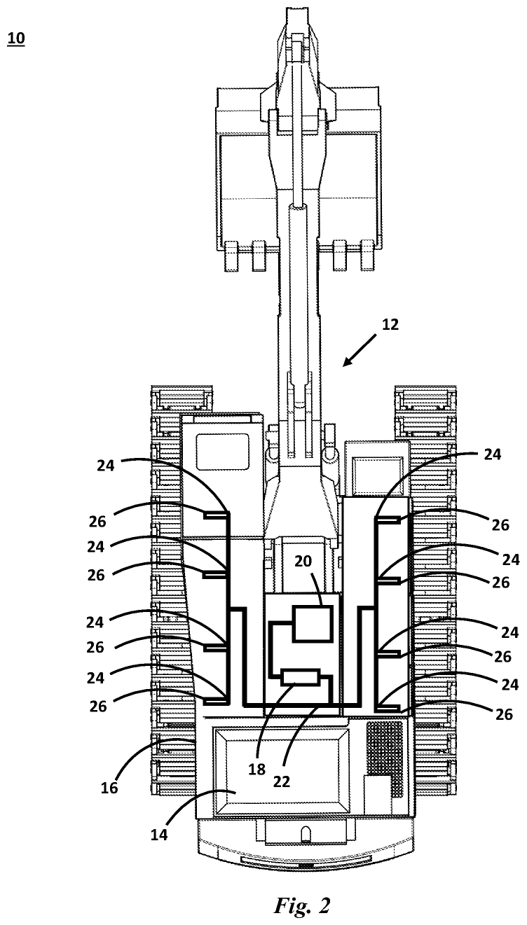

As shown in FIGS. 1 and 2, a thawing system 10 is installed on the undercarriage 16 of a track driven machine 12 having an engine 14. The machine 12 could be any track driven machine such as a bulldozer or an excavator, but the thawing system 10 may be installed on any industrial machine 12 that is prone to ice buildup that must be cleared before the machine 12 may be operated. The thawing system 10 presented herein comprises a heating element 18 in line with a forced air system 20 to heat the undercarriage 16 of the machine 12 and thaw any snow or ice buildup. The heating element 20 may be any of an open-coil heating element, strip heater, tubular air heater, or any element that may produce heat by means of an electric current. The forced air system 20 may be any system that can deliver a pressurized flow of air such as a high-pressure blower or air compressor.

The heating element 18 and forced air system 20 may be powered by the machine's 12 onboard rechargeable battery (not shown) so that the entire thawing system 10 may be operated independently from the engine 14. The batteries used in industrial machines 12 must have a large enough capacity and power output to turn over the machine's 12 large engine 14. These batteries are recharged while the engine 14 is active and generally have more than enough power to run the heating element 18 and the forced air system 20 simultaneously while the engine 14 is not active.

The heating element 18 is in fluid connection with the forced air system 20. When the thawing system 10 is activated, air from the forced air system 20 is heated as it passes through the heating element 18. Heated air then travels into an insulated conduit 22 connected to the outlet of the heating element 18. The conduit 22 comprises a hose or other piping attached to the outlet of the heating element 18 and is arranged to direct the heated air towards the undercarriage 16. The conduit 22 may be insulated with foam, fiberglass, rubber, a chemical coating, or any other material that may prevent heat loss from the air traveling through the conduit 22. The insulated conduit 22 branches into multiple outlets 24 within the undercarriage 16. Each outlet 24 comprises an air nozzle 26 that may direct the heated air to selected areas of the undercarriage 16 that are prone to ice buildup.

The outlet nozzles 26 distribute heated air to the components or groups of components in the undercarriage 16 including the track frame, front idler, top roller, bottom roller, track sprockets, metal shields, track thread, and any other component that may be prone to the buildup of ice and debris. Heated air from the nozzles 26 fills the entirety of the undercarriage 16 and fully envelops any frozen components. Each nozzle 26 may have multiple ports that direct heated air into different areas of the undercarriage 16. Any number of nozzles 26 having any number of ports may be used to warm the undercarriage of the machine 12. It is conceivable that heated air may also be directed to any area on the machine 12 that may need to be thawed for access or maintenance. These areas include but are not limited to access panels and pins/bolts that must be accessed to change the machine's 12 attachments.

This direct, convective heating of frozen undercarriage 16 components is far more efficient than existing thawing systems and serves the added benefit of blowing debris out of the undercarriage 16. Heated air may be delivered to the individual nozzles 26 at a pressure great enough to expel any debris that may have collected during previous operation of the machine 12. Ice, snow, mud, and other debris in the undercarriage 16 of the machine 12 may be quickly melted and ejected from the machine 12 by the flow of heated air from the nozzles 26. Hot air may be delivered to the undercarriage 16 in two stages. The first stage may be lower pressure hot air that primarily serves to melt ice buildup and gradually warm up the components of the undercarriage 16. The second stage may be higher pressure/lower temperature air that is meant to eject mud and debris that were once frozen to the undercarriage 16. Alternatively, the heating element 18 and forced air system 20 may produce the highest temp flow of air at the highest possible pressure throughout the duration of the thawing process for rapid melting and clearing of the undercarriage 16.

The conduit 22 may also run along the machine's 12 other fluid lines such as the hydraulic lines. Heat that conducts through the walls of the conduit 22 will not be wasted as it may warm the fluid within the adjacent lines to prepare the machine 12 for operation. Alternatively, at least one of the system's nozzles may be directed towards the machine's 12 fluid line junctions to provide heat to the machine's 12 hydraulic fluids or oil reservoirs. Heating of these lines helps to warm the machine's 12 hydraulic fluids and oils to lower their viscosity and improve efficiency of the machine 12 once is has been activated.

A machine 12 could be constructed to have a thawing system 10 integrated at the factory or an existing machine 12 could be retrofitted with the thawing system 10. The thawing system 10 may be activated from the cabin of the machine 12 and may automatically shut off when thawing is complete. Retrofitting a thawing system 10 can be accomplished on an existing machine 12 in the following manner: first, the thawing system 10 to be installed is obtained. A plurality of channels are created in the machine 12 to allow passage of the conduit 22 from the heating element 18 to the undercarriage 16. Next, the heating element 18 and the forced air system 20 are fixedly connected to the machine 12 and are wired to the machine's onboard battery. Outlets 24 are positioned within the undercarriage 16 with the nozzles 26 directed towards areas that are prone to ice buildup.

In some embodiments of the thawing system 10, each nozzle 26 of the forced air system 10 may be internally warmed by an electric current from the same power source that warms the heating element 18 and forced air system 20. A heated nozzle 26 could melt any ice buildup in the nozzle's 26 ports before the heating element 18 and the forced air system 20 are activated. Heated nozzles 26 could prevent damage that may occur by attempting to run the thawing system 10 with ice-clogged nozzles 26.

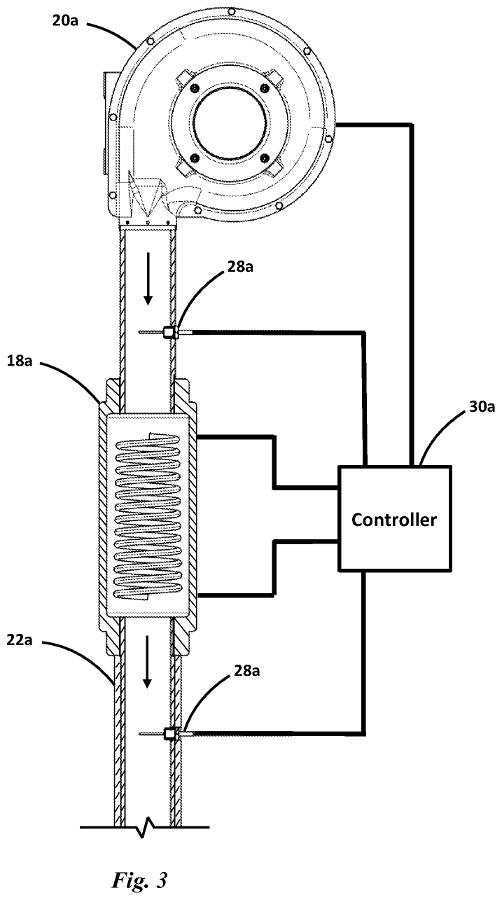

In some embodiments of the thawing system 10a, as shown in FIG. 3, a heat sensor 28a is placed at the input and output of the heating element 18a to quantify the amount of heat being transferred from the heating element 18a to the air from the forced air system 20a. An onboard controller 30a may monitor these heat sensors 28a and adjust the power to the heating element 18a and/or speed of the forced air system 20a to produce air at a desired temperature and volume. Such a feedback loop would improve the efficiency and accuracy of the thawing system 10a, and prevent damage from excessive heating.

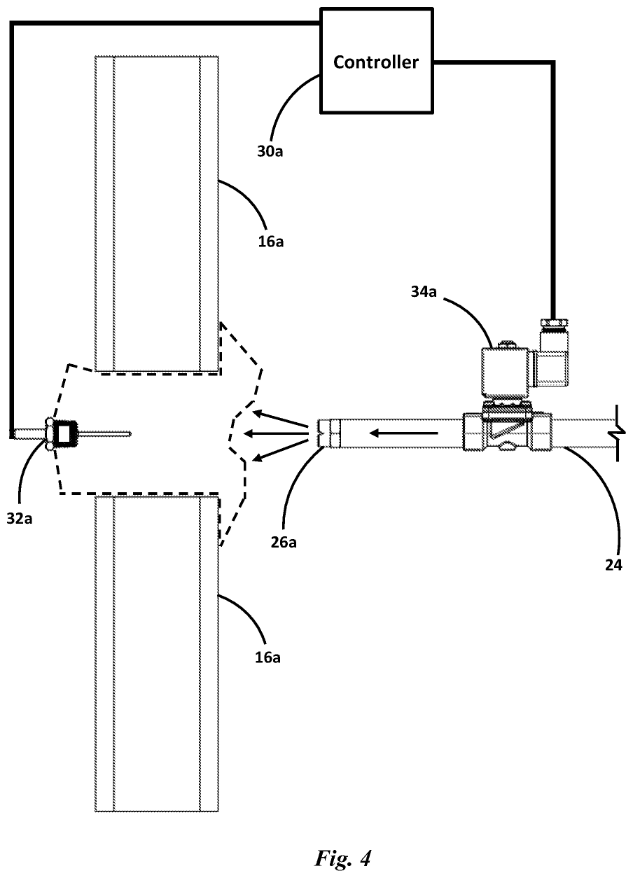

Additional heat sensors 32a may be mounted within the undercarriage 16a to enable automatic shut off of the thawing system 10a when the undercarriage 16a has reached an acceptable temperature. As shown in FIG. 4, heat sensors 32a may be positioned in areas of the undercarriage 16a that are prone to ice buildup such that ice and snow would accumulate around the heat sensors 32a. Each nozzle 26a may be directed towards a heat sensor 32a and may be independently operated by automated valve 34a such as a solenoid valve. Once the buildup around a heat sensor 32a is melted and removed by the heated air, the heat sensor 32a is able to warm up to a designated shutoff temperature. When a heat sensor 32a reaches its designated shutoff temperature, the controller 30a will shut off the automated valve 34a associated with that heat sensor 32a. Automated shutoff of each nozzle 26a prevents damage to the undercarriage 16a due to excessive heating and allows for a greater volume of heated air to flow to areas of the undercarriage 16a that are taking longer to thaw.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A thawing system for heating an undercarriage of a machine, said thawing system comprising:
a forced air system;
a heating element in fluid connection with said forced air system;
an insulated conduit connected to the outlet of said heating element, said conduit is configured to transport heated air from said heating element towards the undercarriage;
a plurality of outlets within the undercarriage that branch from said insulated conduit, each said outlet comprising a nozzle configured to direct heated air to targeted areas of the undercarriage.

2. The thawing system of claim 1 further comprising said forced air system is one of an air blower, an air compressor, or any system capable of producing a pressurized flow of air through said heating element.

3. The thawing system of claim 1 further comprising said heating element is one of an open-coil heating element, a strip heater, a tubular air heater, and any element that may produce heat by means of an electric current.

4. The thawing system of claim 1 further comprising:
the machine comprises an engine and an onboard rechargeable battery; and
said heating element and said forced air system are powered by said onboard rechargeable battery independently from the operation of said engine.

5. The thawing system of claim 1 wherein said conduit is insulated with one of foam, fiberglass, rubber, a chemical coating, and any other material that may prevent heat loss from the air traveling through said conduit.

6. The thawing system of claim 1 further comprising said nozzles distribute heated air to the components or groups of components in the undercarriage that may be prone to the buildup of ice and debris.

7. The thawing system of claim 1 further comprising:
said undercarriage comprises a track frame, a front idler, a top roller, a bottom roller, track sprockets, metal shields, and track thread; and
said nozzles distribute heated air to any combination of said track frame, said front idler, said top roller, said bottom roller, said track sprockets, said metal shields, and said track thread

8. The thawing system of claim 1 further comprising heated air is delivered to each said nozzle at a pressure great enough to expel any debris that may have collected in the undercarriage.

9. The thawing system of claim 1 further comprising a heating element within each said nozzle.

10. The thawing system of claim 1 further comprising a heat sensor at the input and output of the heating element.

11. The thawing system of claim 1 further comprising a heat sensor within each said targeted area of the undercarriage.

12. The thawing system of claim 1 wherein for each said nozzle comprises an automated shutoff valve.
